(19) United States
(12) Patent Application Publication
(10) Pub. No.: US 2002/0181920 A1
(43) Pub. Date: Dec. 5, 2002

(54) Bend limiter for planar optical package

(76) Inventors: Bo A. Andersen, Bridgewater, NJ (US); Stephen K. Fairchild, Mertztown, PA (US); Jay Liu, North Andover, MA (US); Kirk J. Witherow, Perkasie, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/175,758

(22) Filed: Jun. 20, 2002

Related U.S. Application Data
(63) Continuation of application No. 09/723,414, filed on Nov. 28, 2000.

(51) Int. Cl. G02B 6/00

(52) U.S. Cl. 385/134

(57) ABSTRACT

A bend limiting apparatus for use in an automated assembly process of optical components in a planar configuration uses bend limiting tubing and support members. Optical fibers are positioned axially within the bend limiting tubing. The bend limiting tubing is supported by a support member. The optical fibers are attached to a collimated lens assembly. The bend limiting tubing may be coupled to the optical fibers by a pliable adhesive. The bend limiting tubing may also be coupled to the support member by an adhesive such as epoxy. Furthermore, an upper portion may be utilized to provide additional support.

### CROSS REFERENCE TO RELATED APPLICATIONS

The present application is a continuation of U.S. patent application Ser. No. 09/723,414, filed on Nov. 28, 2000, entitled “Bend Limiter For Planar Optical Package”.

### FIELD OF THE INVENTION

The present invention relates to the field of fiberoptics, and specifically to an apparatus and method for limiting bending of a fiber optic cable.

### BACKGROUND

It is often advantageous to limit the bending radius of a fiber optic cable in order to prevent excessive bending and stress in the cable. This is especially applicable to the automated manufacture of devices employing optical fibers. During the manufacturing process, optical fibers are subjected to stresses resulting from various pulls, twists, and bends. The stresses placed on the optical fibers must be within limits such that the fiber is not damaged. Also, devices incorporating optical fibers, after manufacture, must be able to withstand limited stress and strain without sustaining damage.

Testing requirements, such as Bellcore qualification requirements are in place to ensure that components and instruments will perform properly when deployed in the field. Bellcore qualification requirements are recognized by industry, as a standard for optical component testing.

Furthermore, to meet the demand on optical systems for increasing bit rates and data throughput, emphasis is being placed on optical component density. Packaging optical components in a planar (flat) geometry is often preferred over a cylindrical geometry to efficiently utilize space and thus increase component density. The automated manufacturing and assembly of optical components in a planar geometry can subject optical fibers to stresses not inherent in the fabrication of cylindrical packages.

Thus, a need exists to limit the stresses on optical fibers during automated manufacturing and assembly of planar packages.

### SUMMARY OF THE INVENTION

An apparatus for limiting the movement of an optical fiber attached to a planar structure for retaining optical components, comprises a hollow, generally cylindrical sleeve. The sleeve has an outer surface and an inner surface. The optical fiber is positioned within the inner surface of the sleeve and adhesively attached to the inner surface of the sleeve. A support structure is attached to the outer surface of the sleeve.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawing. Various features of the drawing are not to scale. The dimensions of the various features may be arbitrarily expanded or reduced for clarity. Included in the drawing are the following figures:

FIG. 1 is an isometric view of a bend limiting apparatus in accordance with an exemplary embodiment of the invention;

FIG. 2 is an exploded view of an optical component assembly in a planar configuration, incorporating an exemplary embodiment of a bend limiting apparatus in accordance with the present invention;

FIG. 3 is an isometric view of an exemplary embodiment of a bend limiting apparatus showing an upper portion being placed into position;

FIG. 4 is an isometric view of an exemplary bend limiting apparatus with the upper portion in place; and

FIG. 5 is a flow diagram of an automated fabrication process for an optical component package comprising an embodiment of a bend limiting apparatus in accordance with the present invention.

### DETAILED DESCRIPTION

Exemplary embodiments of the present invention comprises a bend limiting apparatus and method for limiting the motion of optical fibers during an automated assembly process. The resultant product of the automated assembly process is an assembly of optical components in a planar package. The bend limiting apparatus comprises a generally cylindrical, hollow tube and a support member. The support member is an integral part of the package and is adhesively attached to the outer surface of the tube. Optical fibers are positioned within the tube. The optical fibers are adhesively attached to the inner surface of the tube with a pliable silicone adhesive, prior to the attaching the fibers to the package. Adhesively attaching the optical fibers to the inner surface of the tube prior to attachment of the fibers to the package facilitates the automated assembly process because the optical fibers and the tubing may be positioned as one component. Thus eliminating the need for the automated positioning process to be interrupted to allow human intervention to slide the tube to the proper location on the optical fiber and apply adhesive to the inner surface of the tube.

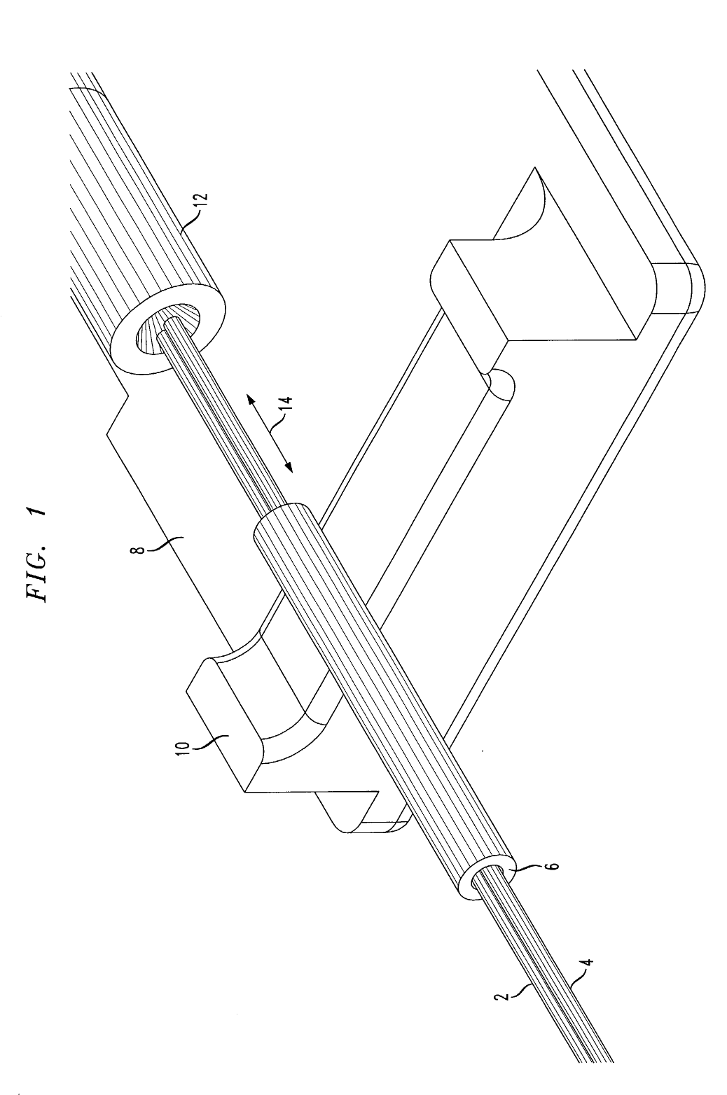

Referring now to the drawings, wherein like reference numbers refer to like elements throughout, FIG. 1 is an isometric view of a bend limiting apparatus in accordance with an exemplary embodiment of the invention. FIG. 1 illustrates the relative positioning of optical fibers 2 and 4, bend limiter tubing 6, base structure 8, support member 10, and collimated lens assembly 12. Optical fibers 2 and 4 are axially positioned within bend limiter tubing 6. Bend limiter tubing 6 is a hollow, generally cylindrical sleeve through which optical fibers 2 and 4 are positioned to limit the bending of the optical fibers. A bend limiting apparatus in accordance with the present invention meets the test requirements for pull, twist, and bend found in the Generic Requirements for Optical Fiber Connectors (TR-NWT-000326), which is referenced in the Generic Requirements for Fiber Optic Branching Components (GR-1209-CORE), which is referenced in the Generic Reliability Assurance Requirements for Fiber Optic Branching Components (GR-1221-CORE). These standards are well known in the art and generally, are collectively referred to as Bellcore standards.

Optical fibers 2 and 4 are attached to the inner surface of bend limiter tubing 6 with a filler material. The filler material may comprise, for example, a commercially available pliable adhesive (e.g., silicone). Attachment of optical fibers 2 and 4 to the inner surface of bend limiter tubing 6 facilitates the automated assembly process by reducing the motion of optical fibers 2 and 4. The filler material reduces axial motion of optical fibers 2 and 4 in the directions indicated by arrow 14. Axial motion may be caused by mechanical strain applied to optical fibers 2 and 4 during the assembly process. Axial motion may also be caused by expansion and contraction of optical fibers 2 and 4, and/or other components, due to thermal variation. Excessive axial motion may cause optical fibers 2 and 4 to bend and ultimately sustain damage. The filler material also reduces radial motion of optical fibers 2 and 4, thus reducing the possibility of any damage due to radial motion.

Support member 10 provides support for bend limiter tubing 6 and optical fibers 2 and 4. In an exemplary embodiment of the invention, optical fibers 2 and 4 are rigidly attached to collimated lens assembly 12. This rigid attachment also contributes to the bending of optical fibers 2 and 4 when subjected to axial motion. The support provided by support member 10 reduces bending of optical fibers 2 and 4, and reduces the possibility of optical fibers 2 and 4 becoming detached from collimated lens assembly 12. In an exemplary embodiment of the invention, bend limiter tubing 6 is attached to support member 10. Attachment of bend limiter tubing 6 to support member 10 may be achieved through the use of, for example, an adhesive such as epoxy. Attachment of bend limiter tubing 6 to support member 10 facilitates the automated assembly process by reducing movement of bend limiter tubing 6, which in turn reduces movement of optical fibers 2 and 4.

It is emphasized that the embodiment of the invention shown in FIG. 1 is exemplary. FIG. 1 shows two optical fibers, 2 and 4. FIG. 1 shows support member 10 as an integral part of base structure 8. It is envisioned that base structure 8 and support member 10 may be separate, but rigidly attached by any appropriate means such as adhesively, snap fit, press fit, or bolted.

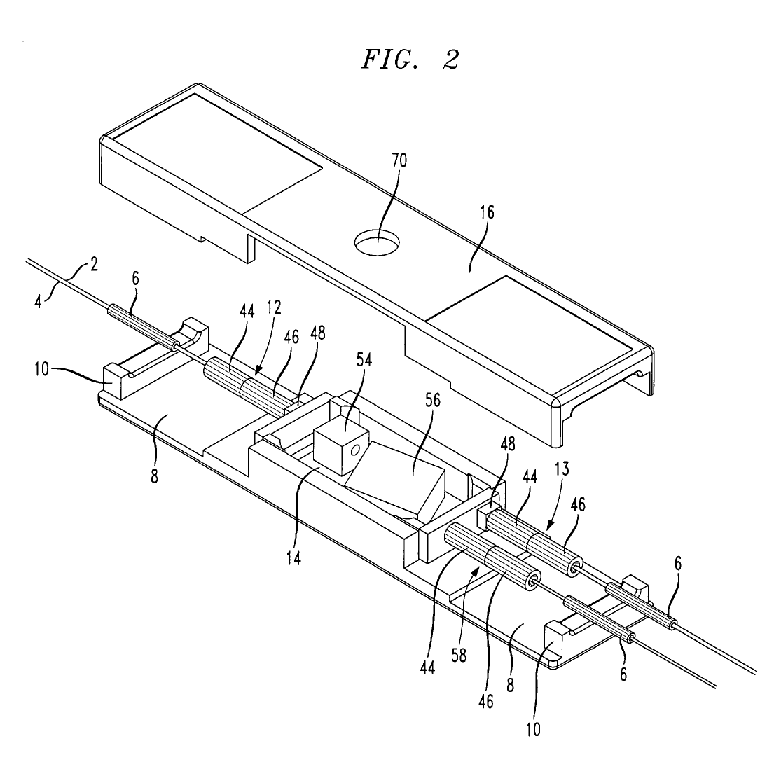

FIG. 2 is an exploded view of an optical component assembly, in a planar configuration, incorporating an exemplary embodiment of a bend limiting apparatus in accordance with the present invention. Bend limiter tubing 6 is positioned around each group of optical fibers coupled to the optical component housing. Placing bend limiter tubing around all optical fibers facilitates the automated assembly process by reducing fiber motion. Support members 10 provide support for all bend limiter tubes 6. Supporting all bend limiter tubes 6 with support member 10 further facilitates the automated assembly process by reducing motion of the optical fibers and bend limiter tubing.

Optical fibers 2 and 4 are coupled to optical components 54 and 56 through collimated lens assembly 12. Collimated lens assemblies may comprise combinations of several components, such as lenses, filters, ferrules, and wavelength division multiplexers (WDMs). Exemplary collimated lens assembly 12 comprises a ferrule 44, a lens 46, and an optical filter 48. Ferrule 44 is a cylindrical device having apertures sized to fit optical fibers 2 and 4. Optical fibers 2 and 4 are mounted in ferrule 44. Ferrule 44 centers and aligns optical fibers 2 and 4. Optical fibers 2 and 4 are termiinated within ferrule 44. Typically, cylindrical ferrules are limited to housing no more than two optical fibers because of the strict tolerances associated with transferring optical energy between a pair of optical fibers.

Lens 46 focuses optical energy provided by optical fiber 2 and 4. Lens 46 may comprise any suitable lens, such as a gradient radial index (hereinafter GRIN) lens, a molded aspheres lens, or a ground spherical lens. In the exemplary embodiment shown in FIG. 2, lens 46 is a GRIN lens. Note that collimated lens assemblies 12 and 13 each comprise filter 48 attached to the lens of the collimated lens assembly. Filter 48 is optional. Note that collimated lens assembly 58 does not comprise a filter. Depending upon system requirements, other optical components (e.g., WDM) may be positioned between the lens of the collimated lens assembly and optical components 54 and 56.

Optical components 54 and 56 represent exemplary optical components which may be retained in region 14, examples of which include lenses, reflectors, isolators, taps, and WDMs. In the exemplary embodiment of the invention shown in FIG. 2, optical component 54 is an isolator and optical component 56 is a prism. In this embodiment, isolator 54 ensures that optical energy is directed toward optical component 56 with minimal reflection of optical energy back toward collimated lens assembly 12. Optical energy which has interacted with isolator 54 is directed toward prism 56. Prism 56, apportions and routes the optical energy received from isolator 54 to collimated lens assemblies 13 and 58.

Isolator 54 and prism 56 form a free air space optical network. Optical energy is coupled between collimated lens assembly 12 and isolator 54, between isolator 54 and prism 56, and between prism 56 and collimated lens assemblies 13 and 58, through air. A free air space optical network may not be appropriate in an environment with high ambient optical energy. In high ambient optical energy environments, it is advantageous to provide a cover, such as upper portion 16 over region 14. Upper portion 16 also protects optical components from damage (e.g., dust, collision, contamination) during storage, shipping, and use. Hole 70, in upper portion 16 may remain open or be filled with material. An example of a filler material for hole 70 is a membrane comprising a wicking agent to withdraw moisture from region 14.

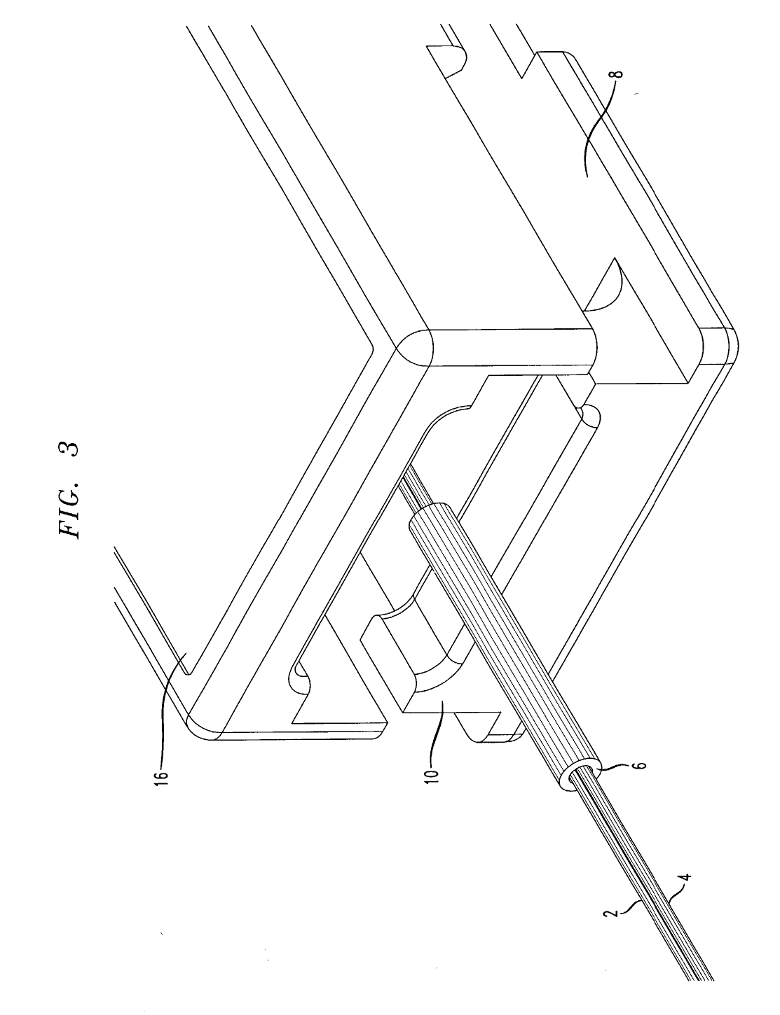

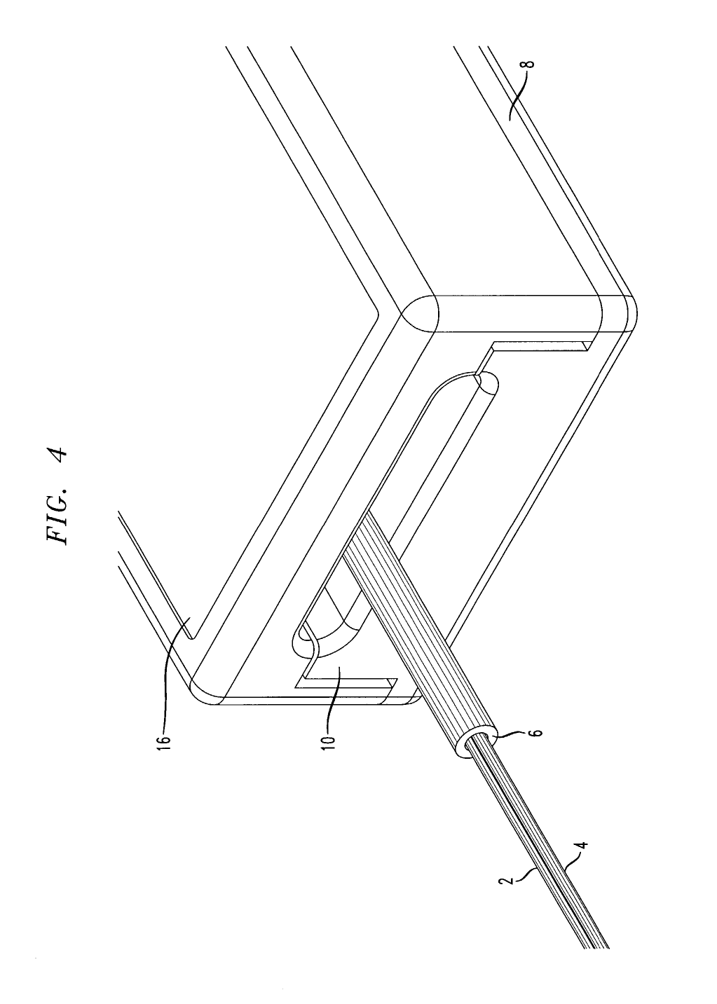

FIG. 3 is an isometric view of an exemplary embodiment of a bend limiting apparatus showing upper portion 16 being placed into position. Upper portion 16 is positioned opposite base structure 8 and support members 10. FIG. 4 is an isometric view of an exemplary bend limiting apparatus with upper portion 16 in place. Upper portion 16 is attached to base structure 8 and/or support member 10. Attachment of upper portion 16 to base structure 8 and/or support member 10 may be accomplished by any means known in the art (e.g., adhesives, press fit, bolts, or snaps). Bend limiting tubing 6 is positioned between, and in physical contact with, support member 10 and upper portion 16, through the use of, for example, an adhesive such as epoxy, or a press fit. Attaching bend limiter tubing 6 to support member 10 and/or upper portion 16 facilitates the automated assembly process by reducing movement of bend limiter tubing 6, which in turn reduces movement of optical fibers 2 and 4.

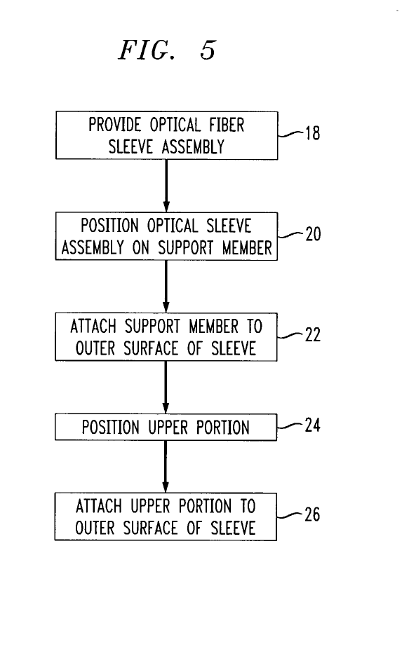

FIG. 5 is a flow diagram of an automated fabrication process for an optical component package comprising an embodiment of a bend limiting apparatus in accordance with the present invention. Reference to FIG. 2 will aid in the description of the process depicted in FIG. 5. One of the components assembled during the automated assembly process is the optic fiber sleeve assembly. The optical fiber sleeve assembly comprises optical fibers 2 and 4, limiter tubing 6, and optionally, a collimated lens assembly. During the fabrication of the optical fiber sleeve assembly, optical fiber 2 and 4 are positioned within the bend limiting tubing 6. The optical fibers are then attached to the inner surface of limiter tubing 6. Attachment of the fibers to the inner surface of limiter tubing 6 may be by any appropriate means, such as adhesively. In one embodiment of the invention, the adhesive comprises a pliable silicone material. One end each of optical fibers 2 and 4 is attached to collimated lens assembly 12, or appropriate optical component, depending upon system requirements.

In step 18, the optical fiber sleeve assembly is provided to the automated assembly mechanism. The automated assembly mechanism may comprise, for example, a conveyor belt and automated positioning devices. In step 20 bend limiting tubing 6, which is now an integral part of the optical fiber sleeve assembly, is positioned on support member 10. Support member 10 may or may not be attached to base structure 8 at this time. In step 22, the outer surface of limiter tube 6 is attached to support member 10. Attachment of the outer surface of limiter tube 6 to support member 10 may be by any appropriate means, such as welded or adhesively attached.

In step 24, upper portion 16 is positioned over support member 10 such that the ends of upper portion 6 are properly aligned with support members 10. Upper portion 16 is attached to either the support member 10 or the base structure 8, or both. Attachment of upper portion 16 to either support member 10 or base structure 8, or both, may be achieved in any of the ways previously described. Bend limiting tubing 6 is attached to upper portion 16 in step 26. Attachment of bend limiting tubing 6 to either upper portion 16 or support member 10, or both, may be achieved in any of the ways previously described (e.g., adhesively, welded, or press fit).

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

APPENDIX B (continued)
Transferred Patents

| Case Name | Filing Date | Issue Data | Patent No. | Serial No. |
|---|---|---|---|---|
| Pearce 15 | 6/30/1999 | | | 09/345679 |
| Pearce 19 | 4/28/1999 | | | 09/300984 |
| Pearce 22 | 6/30/1999 | | | 09/345462 |
| Pearce 26 | 1/5/2000 | | | 80/174566 |
| Pearce 27 | 1/5/2000 | | | 80/174549 |
| Pearce 28 | 1/5/2000 | | | 60/174568 |
| Pearce 31-27 | 8/17/2000 | | 09/641086 | |
| Pelnador 1-1 | 11/3/1999 | | | 09/432926 |
| Pekarich 6-15 | 1/14/2000 | | | 09/483574 |
| Pekarich 6-16 | 1/31/2000 | | | 09/495181 |
| Pekarich 7-17 | 2/17/2000 | | | 09/506019 |
| Pengkuson 1-1-1 | 11/30/1999 | | | 09/451078 |
| Pangkuson 2-1-1 | 1/27/2000 | | | 09/492600 |
| Peon 1-3 | 6/18/1999 | | | 09/338578 |
| Peon 2-4 | 7/29/1999 | | | 09/383781 |
| Philips 2 | 7/20/1998 | | 09/119281 | |
| Philips 7 | 9/4/1998 | | 09/148448 | |
| Philips 8 | 6/30/1999 | | | 09/343385 |
| Pitio 6-3 | 1/3/1994 | | 08/176555 | |
| Poirler 1-2 | 2/5/1999 | | | 09/244658 |
| Poirler 2-3 | 9/29/2000 | | 09/877008 | |
| Polakowski 7-1 | 5/5/2000 | | | 09/588101 |
| Potts 3 | 6/22/1998 | | 09/100892 | |
| Potts 4 | 6/22/1998 | | 09/100891 | |
| Potts 5 | 6/22/1998 | | 09/100890 | |
| Prased 11 | 3/13/1998 | | 09/039151 | |
| Prasad 12 | 3/13/1998 | | 09/042397 | |
| Prasad 13 | 3/13/1998 | | 09/039157 | |
| Prasad 14 | 3/13/1998 | | 09/039158 | |
| Prasad 15 | 3/13/1998 | | 09/039154 | |
| Prasad 17-7 | 3/16/1999 | | | 09/270918 |
| Prasad 18-1 | 12/30/1998 | | | 09/223548 |
| Prasad 2 | 12/12/1997 | | 08/989827 | |
| Prasad 4 | 3/28/1997 | | 08/828455 | |
| Prasad 5 | 10/23/1997 | | 08/955415 | |
| Prasanna 10 | 5/5/1998 | 6/27/2000 | 6081219 | |
| Prasanna 13 | 7/22/1999 | | | 09/359554 |
| Prasanna 18 | 2/23/2000 | | | 09/511089 |
| Prasanna 2 | 2/27/1996 | | 08/607730 | |
| Prasanna 6 | 4/23/1998 | 6/20/2000 | 6078630 | |
| Prasanna 7 | 11/18/1998 | | | 09/193284 |
| Prodanov 3 | 5/28/1999 | | | 09/322961 |
| Prybyte 4 | 8/7/1998 | 4/11/2000 | 6048799 | |
| Prybyte 5-14 | 7/28/1999 | | | 09/362424 |
| Quinlan 5 | 10/2/1996 | | 08/733242 | |
| Quinlan 8-1 | 5/13/1997 | | 08/853738 | |
| Rafferty 5 | 8/30/1999 | | | 09/385258 |
| Rafferty 6-2 | 9/11/2000 | | 08/659668 | |
| Raghunath 10 | 4/30/1997 | | 08/841749 | |
| Raghunath 13 | 6/12/1998 | 5/9/2000 | 6060938 | |
| Raghunath 15-3 | 6/26/1998 | | 09/105783 | |
| Raghunath 8 | 4/30/1997 | | 08/841743 | |
| Rambaud 5-1 | 12/23/1999 | | | 09/471806 |
| Rango 1 | 1/18/2000 | | | 09/488094 |
| Ranslin 4 | 7/20/1998 | | 09/119242 | |
| Ranslin 5 | 7/20/1998 | | 09/119444 | |
| Ranslin 8 | 10/2/2000 | | 09/877469 | |
| Rauchut 2-4-1-1 | 1/12/2000 | | | 09/482390 |
| Reents 5 | 4/2/1998 | 6/13/2000 | 6073478 | |
| Rennig 1 | 7/31/1997 | 6/20/2000 | 6078620 | |

What is claimed is:

1. A bend limiting assembly for limiting movement of at least one optical fiber coupled to a structure for retaining optical components therein, said bend limiting assembly comprising:
a hollow generally cylindrical sleeve having an outer surface and an inner surface;
a support structure attached to said outer surface of said sleeve; and
said at least one optical fiber axially positioned within said inner surface of said sleeve and attached to said inner surface of said sleeve for limiting radial and axial motion of said at least one optical fiber.

2. The bend limiting assembly in accordance with claim 1, wherein said structure for retaining optical components therein is in a planar geometry.

3. The bend limiting assembly in accordance with claim 1, further comprising a filler material for attaching the at least one optical fiber to said inner surface of said sleeve.

4. The bend limiting assembly in accordance with claim 3 wherein said filler material comprises silicone.

5. The bend limiting assembly in accordance with claim 1, wherein said support structure is an integral member of said structure for retaining optical components.

6. The bend limiting assembly in accordance with claim 1 further comprising an adhesive for attaching said support structure to said outer surface of said sleeve.

7. The bend limiting assembly in accordance with claim 1 further comprising an upper portion positioned opposite said support structure, wherein said hollow generally cylindrical sleeve is positioned between said support structure and said upper portion.

8. The bend limiting assembly in accordance with claim 7 wherein said upper portion is attached to at least one of said outer surface of said sleeve and said support structure.

9. The bend limiting assembly in accordance with claim 8 further comprising an adhesive for attaching to at least one of said upper portion to said outer surface of said sleeve and said support structure.

10. A method for assembling an optical component package having a bend limiting assembly, said method comprising the steps of:
(a) providing an optical fiber sleeve assembly comprising:
a hollow generally cylindrical sleeve having an outer surface and an inner surface; and
at least one optic fiber axially positioned within said inner surface of said sleeve and attached to said inner surface of said sleeve for limiting radial and axial motion of said at least one optical fiber;
(b) attaching a support member to said outer surface of said sleeve; and
(c) attaching an upper portion to said outer surface of said sleeve.

11. The method in accordance with claim 10, wherein said at least one optic fiber is adhesively attached to said inner surface with a filler material.

12. The method in accordance with claim 11, wherein the filler material comprises silicone.

13. The method in accordance with claim 11, wherein said support member is adhesively attached to said outer surface of said sleeve.

14. A bend limiting assembly for limiting movement of at least one optical fiber coupled to a structure for retaining optical components therein, said bend limiting assembly comprising:
a hollow generally cylindrical sleeve having an outer surface and an inner surface;
a support structure attached to said outer surface of said sleeve; and
a pliable adhesive for attaching and limiting motion of the at least one optical fiber to said inner surface of said sleeve, wherein:
said at least one optical fiber is axially positioned within said inner surface of said sleeve; and
radial and axial motion of said at least one optical fiber within and protruding from said sleeve is limited.
